(19) United States
(12) Patent Application Publication
(10) Pub. No.: US 2023/0223164 A1
(43) Pub. Date: Jul. 13, 2023

(54) Cable comprising a semiconductive layer with a smooth surface

(71) Applicant: NEXANS, Courbevoie (FR)

(72) Inventors: Christian KOELBLIN, MEXIMIEUX (FR); Christelle MAZEL, RUY (FR); Gabriele PEREGO, MILANO (IT); ,Paul Charles BARUSTA, LYON (FR)

(21) Appl. No.: 17/909,362

(22) PCT Filed: Mar. 3, 2021
(86) PCT No.: PCT/FR2021/050364

§ 371 Date: Sep. 3, 2022

(30) Foreign Application Priority Data
Mar. 6, 2020 (FR) 20 02270

(51) Int. Cl. H01B 1/12; C08L 23/14

(52) U.S. Cl. CPC H01B 1/124; C08L 23/14; C08L 2203/202

(57) ABSTRACT

The present invention relates to an electric cable comprising at least one semiconductive layer obtained from a polymer composition comprising at least one homophasic propylene polymer and at least one homophasic copolymer of a C₃-C₆ olefin and ethylene.

The present invention relates to an electric cable comprising at least one semiconductive layer obtained from a polymer composition comprising at least one homophasic propylene polymer and at least one homophasic copolymer of a C₃-C₆ olefin and ethylene.

The invention typically but not exclusively applies to electric cables intended for power transmission, notably to medium-voltage (notably from 6 to 45-60 kV) or high-voltage (notably greater than 60 kV, and which can go up to 400 kV) power cables, whether in direct or alternating current, in the fields of aerial, submarine or terrestrial power transmission, or even in aeronautics. The invention applies in particular to electric cables comprising at least one semiconductive layer with a smooth surface state.

A semiconductive layer of an electric cable is generally obtained by dispersing conductive particles such as carbon black particles in an ethylene-based polymer matrix. However, during the manufacture of the compositions used for obtaining these semiconductive layers, such particles are very often difficult to disperse in the polymers used as matrix. During the extrusion of the semiconductive layers either around the cable conductor or around the insulating layer, poorly incorporated carbon black particles can be found at the interface between a semiconductive layer and the insulating layer, and can form protuberances surrounded by the insulating layer. These protuberances will lead to a localized increase in the electric field, which can cause premature ageing of the cable, said ageing possibly causing an electric breakdown.

There is thus a need for semiconductive layers for electric cables with an improved surface state.

International patent application WO 2018/100 409 A1 discloses a semiconductive layer for an electric cable, obtained from a polymer composition comprising a heterophasic copolymer of propylene and ethylene having an enthalpy of fusion of 23 J/g and comprising about 70% by weight of an elastomeric phase, a random copolymer of propylene and ethylene having an enthalpy of fusion of 78 J/g, carbon black as conductive filler, and dibenzyltoluene as dielectric fluid. The surface state of the semiconductive layer thus obtained is not optimized.

The aim of the present invention is consequently to overcome the drawbacks of the prior art techniques by proposing an electric cable, notably a medium-voltage or high-voltage cable, said cable having an improved surface state (i.e. in which the protuberances are reduced and/or the surface state has a smooth appearance), preferably while at the same time ensuring good mechanical properties.

The aim is achieved by the invention which will be described hereinbelow.

A first subject of the invention is an electric cable comprising at least one elongated electrically conductive element, and at least one semiconductive layer surrounding said elongated electrically conductive element, characterized in that the semiconductive layer is obtained from a polymer composition comprising at least one homophasic propylene polymer, and at least one homophasic copolymer of a C₃-C₆ olefin and ethylene.

Thus, by virtue of the combination of a homophasic propylene polymer and a homophasic copolymer of a C₃-C₆ olefin and ethylene, the semiconductive layer thus obtained has an improved surface state, notably a smooth appearance and/or a reduction in the number of protuberances, preferably while at the same time ensuring good mechanical properties.

The Polymer Composition

The Conductive Filler

The polymer composition in particular comprises at least one conductive filler, notably in an amount that is sufficient to render the layer semiconductive.

The polymer composition may comprise at least about 6% by weight of conductive filler, preferably at least about 15% by weight of conductive filler, and particularly preferably at least about 25% by weight of conductive filler, relative to the total weight of the polymer composition.

The polymer composition may comprise at most about 45% by weight of conductive filler, and preferably at most about 40% by weight of conductive filler, relative to the total weight of the polymer composition.

The conductive filler is preferably an electrically conductive filler.

The conductive filler may be advantageously chosen from carbon blacks, for instance acetylene blacks or furnace blacks, graphites, and a mixture thereof.

Preferably, the conductive filler is a furnace black. Although attractive in terms of cost and widely marketed, furnace black is generally not preferred for obtaining a good surface quality since it is generally in the form of coarse particles and/or comprises ionic contaminants. Nevertheless, in the present invention, the combination of a homophasic propylene polymer, and a homophasic copolymer of a C₃-C₆ olefin and ethylene ensures a good surface quality in the presence of any type of conductive filler, and in particular furnace black.

The conductive filler may be in the form of particles, nodules or aggregates, notably of micrometric size (for example greater than 0.1 μm, and preferably greater than 0.5 μm).

When considering a plurality of particles, nodules or aggregates of the conductive filler powder according to the invention, the term “size” means the number-average size of all the particles of a given population, this size being conventionally determined via methods that are well known to those skilled in the art.

The size of the particle(s) according to the invention can be determined, for example, by microscopy, notably by scanning electron microscopy (SEM) or by transmission electron microscopy (TEM).

The presence of a homophasic propylene polymer and a homophasic copolymer of a C₃-C₆ olefin and ethylene makes it possible to incorporate sufficient conductive filler to make the layer semiconductive, while at the same time ensuring good mechanical properties. On the contrary, LDPE does not makes it possible to incorporate enough conductive filler without avoiding degradation of the mechanical properties.

The incorporation of the conductive filler during the mixing process greatly increases the shear applied to the two polymers melted together, promoting the formation of a homogeneous composition.

In the present invention, the term “polymer” means any type of polymer, for instance homopolymers or copolymers (e.g. block copolymer, random copolymer, terpolymer, etc.).

In the present invention, the term “homophasic polymer” means any polymer having a single phase, or a substantially homogeneous phase.

More particularly, a homophasic polymer is not a heterophasic polymer. As examples of heterophasic polymers, mention may be made of heterophasic propylene copolymers, for instance those described in WO 2011/092 533, namely: Adflex Q200F or Hifax CA 7441A, from the company Basell (LyondellBasell).

The heterophasic polymer comprises at least two distinct phases: one comprising a polymer matrix, and the other comprising particles or nodules dispersed in this polymer matrix, which can be, for example, an elastomeric phase. This type of polymer can be readily identified via techniques that are well known to those skilled in the art, for instance by scanning electron microscopy (SEM). More particularly, at 10 000× magnification, it is conventional to observe said particles or nodules dispersed in said polymer matrix, said particles having a number-average size ranging from 200 nm to 10 μm, and preferably between 500 nm and 1 μm.

A homophasic polymer notably does not comprise such particles or nodules dispersed in a polymer matrix. Specifically, by means of SEM analysis, a single substantially homogeneous phase can be observed. More particularly, at 10 000× magnification, it is conventional to observe a homogeneous polymer matrix which is substantially free of particles or nodules dispersed in said matrix.

In the polymer composition of the invention, the homophasic propylene polymer is different from the homophasic copolymer of a C₃-C₆ olefin and ethylene.

The Homophasic Propylene Polymer

The homophasic propylene polymer may be a propylene homo- or copolymer, and preferably a propylene copolymer.

As examples of propylene copolymers, mention may be made of copolymers of propylene and an olefin, the olefin being notably chosen from ethylene and an α-olefin other than propylene.

The ethylene or the α-olefin other than propylene of the propylene copolymer preferably represents at most about 15% by weight, and particularly preferably at most about 10% by weight, relative to the total weight of propylene copolymer.

The ethylene or α-olefin other than propylene of the propylene copolymer preferably represents at most about 20 mol %, particularly preferably at most about 15 mol %, and more particularly preferably at most about 10 mol %, relative to the total number of moles of propylene copolymer.

The molar percentage of ethylene or α-olefin in the propylene copolymer may be determined by nuclear magnetic resonance (NMR), for example according to the method described in Masson et al., Int. J. Polymer Analysis & Characterization, 1996, Vol. 2, 379-393.

The α-olefin other than propylene may have the formula CH₂═CH—R¹, in which R¹ is a linear or branched alkyl group containing from 2 to 12 carbon atoms, notably chosen from the following α-olefins: 1-butene, 1-pentene; 4-methyl-1-pentene, 1-hexene, 1-octene, 1-decene, 1-dodecene, and a mixture thereof.

The propylene copolymer is preferably a copolymer of propylene and ethylene.

The propylene copolymer may be a random propylene copolymer, and preferably a random copolymer of propylene and ethylene.

In the invention, the propylene homopolymer or copolymer preferably has an elastic modulus ranging from about 600 to about 1200 MPa, and particularly preferably ranging from about 800 to about 1100 MPa.

In the present invention, the elastic modulus is preferably determined according to the standard ISO 527-1, -2 (2019).

An example of a propylene random copolymer that may be mentioned is the product sold by the company Borealis under the reference Bormed® RB 845 MO or the product sold by the company Total Petrochemicals under the reference PPR3221.

The propylene homopolymer or copolymer may have a melting point of greater than about 110° C., preferably greater than about 120° C., particularly preferably greater than or equal to about 125° C., and more particularly preferably ranging from about 130 to about 160° C.

The propylene homopolymer or copolymer may have an enthalpy of fusion ranging from about 20 to about 100 J/g, preferably ranging from about 40 to about 90 J/g, and particularly preferably ranging from 50 to 85 J/g.

The propylene homopolymer or copolymer may have a melt flow index ranging from 0.5 to 3 g/10 min, preferably from 1.0 to 2.75 g/10 min, and particularly preferably from 1.2 to 2.5 g/10 min; notably determined at about 230° C. with a load of about 2.16 kg according to the standard ASTM D1238-00, or the standard ISO 1133.

The propylene homopolymer or copolymer may have a density ranging from about 0.81 to about 0.92 g/cm³, preferably ranging from 0.85 to 0.91 g/cm³, and particularly preferably ranging from 0.88 to 0.91 g/cm³; notably as determined according to the standard ISO 1183A (at a temperature of 23° C.).

The polymer composition may comprise at least about 20% by weight, and preferably at least about 30% by weight of the homophasic propylene polymer, relative to the total weight of the polymer composition.

The polymer composition may comprise at most about 80% by weight, and preferably at most about 60% by weight of the homophasic propylene polymer, relative to the total weight of the polymer composition.

The Homophasic Copolymer of a C₃-C₆ Olefin and Ethylene

In the homophasic copolymer of a C₃-C₆ olefin and ethylene of the invention, the C₃-C₆ olefin is preferably in the majority (i.e. greater than about 50 mol %, relative to the total number of moles of homophasic copolymer of a C₃-C₆ olefin and ethylene). More particularly, the molar proportion of C₃-C₆ olefin is greater than that of ethylene in said copolymer, relative to the total number of moles of homophasic copolymer of a C₃-C₆ olefin and ethylene.

The ethylene of the homophasic copolymer of a C₃-C₆ olefin and ethylene preferably represents at most about 25 mol %, particularly preferably at most about 20 mol %, and more particularly preferably at most 15 mol %, relative to the total number of moles of homophasic copolymer of a C₃-C₆ olefin and ethylene.

The homophasic copolymer of a C₃-C₆ olefin and ethylene preferably has a degree of crystallinity of at least about 10%, particularly preferably ranging from about 12% to about 35%, and more particularly preferably ranging from about 15% to about 25%, the degree of crystallinity being determined, for example, by DSC (differential scanning calorimetry) or by X-ray diffraction (according to the Debye-Scherrer principle).

The C₃-C₆ olefin may have the formula CH₂═CH—R², in which R² is a linear or branched alkyl group containing from 1 to 4 carbon atoms, notably chosen from the following olefins: propylene, 1-butene, 1-pentene; 4-methyl-1-pentene, 1-hexene, and a mixture thereof.

The homophasic copolymer of a C₃-C₆ olefin and ethylene is preferably a homophasic copolymer of a C₃-05 olefin and ethylene, particularly preferably a homophasic copolymer of a C₃-C₄ olefin and ethylene, and more particularly preferably a homophasic copolymer of propylene (i.e. C₃) and ethylene.

As examples of a homophasic copolymer of propylene and ethylene, mention may be made of the product sold by the company Dow under the reference Versify® 2300, or the product sold by the company Exxon Mobil Chemical under the reference Vistamaxx® 3020FL.

The homophasic copolymer of a C₃-C₆ olefin and ethylene may have an enthalpy of fusion of at most about 50 J/g, preferably at most about 25 J/g, and particularly preferably ranging from 0.5 to 15 J/g.

The homophasic copolymer of a C₃-C₆ olefin and ethylene may have a melt flow index ranging from 0.5 to 25 g/10 min, preferably from 1.0 to 10 g/10 min, and particularly preferably from 1.0 to 5 g/10 min; notably determined at about 230° C. with a load of about 2.16 kg according to the standard ASTM D1238-00 or ISO 1133.

The homophasic copolymer of a C₃-C₆ olefin and ethylene may have a density ranging from about 0.82 to about 0.89 g/cm³, and preferably ranging from 0.85 to 0.88 g/cm³; notably according to the standard ISO 1183A (at a temperature of 23° C.).

The homophasic copolymer of a C₃-C₆ olefin and ethylene preferably has a Vicat temperature of at most about 90° C., particularly preferably at most about 80° C., and more particularly preferably at most about 75° C.

The homophasic copolymer of a C₃-C₆ olefin and ethylene may have a Vicat softening temperature of at least about 20° C., preferably at least about 25° C., and particularly preferably at least about 30° C.

In the present invention, the Vicat temperature, in other words the Vicat softening point (also known as the Vicat softening temperature) may be readily determined according to the standard ISO 306 Method A (2013).

The polymer composition may comprise at least about 10% by weight, and preferably at least about 20% by weight of the homophasic copolymer of a C₃-C₆ olefin and ethylene, relative to the total weight of the polymer composition.

The polymer composition may comprise at most about 50% by weight, and preferably at most about 40% by weight of the polymer of the homophasic copolymer of a C₃-C₆ olefin and ethylene, relative to the total weight of the polymer composition.

According to a preferred embodiment of the invention, the homophasic copolymer of a C₃-C₆ olefin and ethylene is obtained by a copolymerization process using a single-site catalyst, for instance a metallocene catalyst that is well known to those skilled in the art. A copolymer obtained via this type of copolymerization is commonly referred to as a metallocene copolymer.

The “metallocene” copolymers of a C₃-C₆ olefin and ethylene have more regular molecular structures (i.e. they have a “narrow” molecular mass distribution, also known as a polymer with a “low polydispersity”), which gives them excellent mechanical properties, notably excellent elongation at break, even in the presence of fillers in large contents.

In addition, the “metallocene” copolymers of a C₃-C₆ olefin and ethylene have a higher degree of purity relative to the catalyst residues that are found in the copolymer after its manufacture, when compared with the copolymers of a C₃-C₆ olefin and ethylene obtained via polymerization processes using catalysts of Ziegler-Natta or metal oxide type.

Thus, metallocene copolymers of a C₃-C₆ olefin and ethylene show better resistance to thermal degradation (i.e. heat stress) and to ageing by cracking (known as ESCR meaning Environmental Stress Cracking Resistance) than copolymers of a C₃-C₆ olefin and ethylene with a substantially identical degree of crystallinity obtained via a different copolymerization process.

Said copolymer may conventionally be obtained by copolymerizing ethylene with at least said C₃-C₆ olefin comonomer in the presence of a metallocene catalyst that is well known to those skilled in the art.

In the polymer composition of the invention, the homophasic propylene polymer is generally present in a larger amount than the homophasic copolymer of a C₃-C₆ olefin and ethylene. This thus improves the thermomechanical strength or the strain resistance of the semiconductive layer, and limits its production cost.

Other Polymers in the Polymer Composition

The polymer composition may also comprise at least one ethylene polymer such as an ethylene polymer chosen from low density ethylene polymers (LDPE), linear low density ethylene polymers (LLDPE), medium density ethylene polymers (MDPE), and high density ethylene polymers (HDPE). Preferably, the ethylene polymer is an LLDPE or an MDPE.

In the present invention, the term “low density” means having a density ranging from about 0.91 to about 0.925, said density being measured according to the standard ISO 1183A (at a temperature of 23° C.).

In the present invention, the term “medium density” means having a density ranging from about 0.926 to about 0.940, said density being measured according to the standard ISO 1183A (at a temperature of 23° C.).

In the present invention, the term “high density” means having a density ranging from 0.941 to 0.965, said density being measured according to the standard ISO 1183A (at a temperature of 23° C.).

The ethylene polymer preferably comprises at least about 80 mol % of ethylene, particularly preferably at least about 90 mol % of ethylene, and more particularly preferably at least about 95 mol % of ethylene, relative to the total number of moles of the ethylene polymer.

The molar percentage of ethylene in the ethylene polymer can be determined by nuclear magnetic resonance (NMR), for example according to the method described in Masson et al., Int. J. Polymer Analysis & Characterization, 1996, Vol. 2, 379-393.

The polymer composition preferably does not comprise any heterophasic propylene polymer(s). Specifically, the presence of such a polymer may cause deformation of the semiconductive layer at the operating temperature of the cable, and increase the production cost of the cable.

The polymer composition of the cable of the invention may comprise at most about 20% by weight, preferably at most about 10% by weight, and particularly preferably at most about 5% by weight, of polar polymer(s) relative to the total weight of polymer(s) in the polymer composition.

In the present invention, the term “polar” means that the polymer of this type includes one or more polar functions, for instance acetate, acrylate, hydroxyl, nitrile, carboxyl, carbonyl, ether or ester groups, or any other groups of a polar nature that are well known in the prior art, notably such as silane groups. For example, a polar polymer is a polymer chosen from ethylene copolymers of the type such as ethylene/vinyl acetate (EVA) copolymer, ethylene/butyl acrylate (EBA) copolymer, ethylene/ethyl acrylate (EEA) copolymer, ethylene/methyl acrylate (EMA) copolymer, ethylene/acrylic acid (EAA) copolymer, and ethylene/vinyl silane copolymer.

The polymer composition preferably does not comprise any polar polymer(s). Specifically, such polymers may decrease the thermal ageing resistance of the semiconductive layer of the invention.

The homophasic propylene polymer and the homophasic copolymer of a C₃-C₆ olefin and ethylene as defined in the invention may represent at least about 50% by weight, preferably at least about 70% by weight, and particularly preferably at least about 80% by weight, relative to the total weight of polymer(s) in the polymer composition.

More particularly, the polymer composition may comprise only the homophasic propylene polymer, and the homophasic copolymer of a C₃-C₆ olefin and ethylene, as defined in the invention, as the polymer(s).

The homophasic propylene polymer and the homophasic copolymer of a C₃-C₆ olefin and ethylene are not necessarily miscible in the polymer composition. In other words, their miscibility is not essential to obtain a semiconductive layer with an improved surface state, notably a smooth appearance and/or with a reduced number of protuberances, preferably while at the same time ensuring good mechanical properties.

The composition of the invention is a homogeneous composition in the sense that it is in the form of a single polymer phase in the case where the polymers are miscible, or in the form of at least two phases, the first being uniformly dispersed in the second to form a homogeneous composition.

The homophasic propylene polymer and the homophasic copolymer of a C₃-C₆ olefin and ethylene have the advantage of not producing significant phase separation in the molten state, facilitating their mixing and extrusion to form the semiconductive layer.

The Dielectric Fluid

The polymer composition of the invention may also comprise a dielectric fluid, notably forming an intimate mixture with the polymers of the polymer composition.

The dielectric fluid is also well known to those skilled in the art as a “dielectric oil” or a “dielectric liquid”.

As examples of dielectric fluids, mention may be made of mineral oils (e.g. naphthenic oils, paraffinic oils, or aromatic oils); plant oils (e.g. soybean oil, linseed oil, rapeseed oil, corn oil, or castor oil); or synthetic oils such as aromatic hydrocarbons (alkylbenzenes, alkylnaphthalenes, alkylbiphenyls, alkyldiarylethylenes, etc.), silicone oils, ether oxides, organic esters or aliphatic hydrocarbons.

Aromatic hydrocarbons, silicone oils, and aliphatic hydrocarbons are preferred as synthetic oils.

According to a particular embodiment, the dielectric fluid represents from about 1% to about 20% by weight, preferably from about 2% to about 15% by weight, and particularly preferably from about 3% to about 12% by weight, relative to the total weight of the polymer composition.

The dielectric fluid preferably comprises at least one mineral oil.

The mineral oil is generally liquid at about 20-25° C.

The mineral oil is advantageously chosen from naphthenic oils and paraffinic oils.

The mineral oil is obtained from the refining of a petroleum crude oil.

According to a particularly preferred embodiment of the invention, the mineral oil comprises a paraffinic carbon (Cp) content ranging from about 45 at % to about 65 at %, a naphthenic carbon (Cn) content ranging from about 35 at % to about 55 at %, and an aromatic carbon (Ca) content ranging from about 0.5 at % to about 10 at %.

The dielectric fluid may comprise at least about 70% by weight of mineral oil, preferably at least about 80% by weight of mineral oil, and particularly preferably at least about 90% by weight of mineral oil relative to the total weight of the dielectric fluid.

According to a preferred embodiment of the invention, the dielectric fluid comprises a mineral oil and at least one polar compound such as benzophenone, acetophenone or a derivative thereof.

In a particular embodiment, the polar compound such as benzophenone, acetophenone or a derivative thereof represents at least about 2.5% by weight, preferably at least about 3.5% by weight, and particularly preferably at least about 4% by weight, relative to the total weight of the dielectric fluid.

According to a preferred embodiment of the invention, the polar compound such as benzophenone, acetophenone or a derivative thereof is chosen from benzophenone, dibenzosuberone, fluorenone and anthrone. Benzophenone is particularly preferred.

Additives

The polymer composition may also comprise one or more additives.

The additives are well known to those skilled in the art.

The additives may be chosen from antioxidants, processing aids such as lubricants, metal deactivators, compatibilizers, couplers, UV inhibitors, water tree reducing compounds, pigments, and a mixture thereof.

The polymer composition may typically comprise from about 0.01% to about 5% by weight, and preferably from about 0.1% to about 2% by weight of additive(s), relative to the total weight of the polymer composition.

The antioxidant may be chosen from hindered phenols, aromatic amines, nitrogenous aromatic heterocycles, sulfur-based antioxidants, and phosphorus-based antioxidants, and preferably from hindered phenols.

As examples of hindered phenols, mention may be made of pentaerythrityl tetrakis(3-(3,5-di-tert-butyl-4-hydroxyphenyl)propionate) (Irganox® 1010), octadecyl 3-(3,5-di-tert-butyl-4-hydroxyphenyl)propionate (Irganox® 1076), 1,3,5-trimethyl-2,4,6-tris(3,5-di-tert-butyl-4-hydroxybenzyl)benzene (Irganox® 1330), 4,6-bis(octylthiomethyl)-o-cresol (Irgastab® KV10 or Irganox® 1520), 2,2′-thiobis(6-tert-butyl-4-methylphenol) (Irganox® 1081), 2,2′-thiodiethylenebis[3-(3,5-di-tert-butyl-4-hydroxyphenyl) propionate] (Irganox® 1035), 2,2′-methylenebis(6-tert-butyl-4-methylphenol) or tris(3,5-di-tert-butyl-4-hydroxybenzyl) isocyanurate (Irganox® 3114).

As examples of aromatic amines, mention may be made of phenylenediamines (e.g. para-phenylenediamines such as 1PPD or 6PPD), diphenylaminestyrenes, diphenylamines, or 4-(1-methyl-1-phenylethyl)-N-[4-(1-methyl-1-phenylethyl)phenyl]aniline (Naugard 445).

As examples of nitrogenous aromatic heterocycles, mention may be made of mercaptobenzimidazoles or quinoline derivatives such as polymerized 2,2,4-trimethyl-1,2-dihydroquinolines (TMQ), and preferably mercaptobenzimidazoles.

As examples of sulfur-based antioxidants, mention may be made of thioethers such as didodecyl 3,3′-thiodipropionate (Irganox® PS800), distearyl thiodipropionate or dioctadecyl 3,3′-thiodipropionate (Irganox® PS802), bis[2-methyl-4-{3-n-alkyl (C₁₂ or C₁₄) thiopropionyloxy}-5-tert-butylphenyl] sulfide, thiobis[2-tert-butyl-5-methyl-4,1-phenylene]bis[3-(dodecylthio)propionate], or 4,6-bis(octylthiomethyl)-o-cresol (Irganox® 1520 or Irgastab® KV10).

As examples of phosphorus-based antioxidants, mention may be made of phosphites or phosphonates, such as tris(2,4-di-tert-butylphenyl) phosphite (Irgafos® 168) or bis(2,4-di-tert-butylphenyl)pentaerythrityl diphosphite (Ultranox® 626).

The metal deactivator may be chosen from nitrogenous aromatic heterocycles, and aromatic compounds comprising at least one —NH—C(═O)— function, and preferably from aromatic compounds comprising at least one —NH—C(═O)— function. The presence of oxygen in the metal deactivator is important to be able to durably immobilize the metal ions.

As examples of nitrogenous aromatic heterocycles, mention may be made of quinoline derivatives such as polymerized 2,2,4-trimethyl-1,2-dihydroquinolines (TMQs).

As examples of aromatic compounds comprising at least one —NH—C(═O)— function, mention may be made of those comprising two —NH—C(═O)— functions, preferably comprising two covalently bonded —NH—C(═O)— functions, and more particularly preferably comprising a divalent group —NH—C(═O)—C(═O)—NH— or —C(═O)—NH—NH—C(═O)—, such as 2,2′-oxamidobis[ethyl-3-(3,5-di-tert-butyl-4-hydroxyphenyl) propionate] (Naugard XL-1), 2′,3-bis[[3-[3,5-di-tert-butyl-4-hydroxyphenyl]propionyl] propionohydrazide or 1, 2-bis(3,5-di-tert-butyl-4-hydroxyhydrocinnamoyl)hydrazine (Irganox® 1024 or Irganox® MD 1024), or oxalyl bis(benzylidenehydrazide) (OABH).

The polymer composition of the semiconductive layer of the invention is a thermoplastic polymer composition. It is thus not crosslinkable.

In particular, the polymer composition does not comprise any crosslinking agents, silane couplers, peroxides and/or additives that enable crosslinking. The reason for this is that such agents degrade the polymer(s) of the polymer composition.

The polymer composition is preferably recyclable.

The composition may also comprise inert inorganic fillers such as chalk, kaolin or talc; and/or halogen-free mineral fillers intended to improve the fire behaviour of the polymer composition.

The inert inorganic fillers and/or halogen-free inorganic fillers may represent at most about 30% by weight, preferably at most about 20% by weight, particularly preferably at most about 10% by weight, and particularly preferably from about 0.1 to about 5% by weight, relative to the total weight of the polymer composition.

In order to provide an electric cable which is an “HFFR” (“halogen-free flame-retardant”) cable, the cable of the invention preferentially does not comprise any halogenated compounds. These halogenated compounds may be of any nature, for instance fluorinated polymers or chlorinated polymers such as polyvinyl chloride (PVC), halogenated plasticizers, halogenated mineral fillers, etc.

The Semiconductive Layer

The semiconductive layer of the cable of the invention is preferably a non-crosslinked layer, in other words a thermoplastic layer.

In the invention, the term “non-crosslinked layer” or “thermoplastic layer” means a layer with a gel content according to the standard ASTM D2765-01 (xylene extraction) of not more than about 30%, preferably not more than about 20%, particularly preferably not more than about 10%, more particularly preferably not more than about 5%, and even more particularly preferably 0%.

In one embodiment of the invention, the preferably non-crosslinked semiconductive layer has a tensile strength of at least about 7 MPa, preferably at least about 10 MPa, and particularly preferably at least about 12.5 MPa.

The tensile strength is measured by a tensile test on an H2 dumbbell specimen, in particular at a tensile speed of 25 mm/min.

In a particularly preferred embodiment of the invention, the preferably non-crosslinked semiconductive layer has an elongation at break of at least about 150%, preferably at least about 250%, and particularly preferably at least about 350%.

The elongation at break is measured by a tensile test on an H2 dumbbell specimen, in particular at a tensile speed of 25 mm/min.

The semiconductive layer of the cable of the invention is preferably a recyclable layer.

The semiconductive layer of the invention may be a layer that is extruded, notably by processes that are well known to those skilled in the art.

The semiconductive layer has a thickness that is variable as a function of the type of cable envisaged. In particular, when the cable in accordance with the invention is a medium-voltage cable, the thickness of the semiconductive layer is typically from about 0.3 to about 1.5 mm, and more particularly about 0.5 mm. When the cable according to the invention is a high-voltage cable, the thickness of the semiconductive layer typically ranges from 1.0 to 4 mm (for voltages of the order of about 150 kV) and up to thicknesses ranging from about 3 to about 5 mm for voltages above 150 kV (very high voltage cables). The abovementioned thicknesses typically depend, inter a/ia, on the size of the elongated electrically conductive element.

In the present invention, the term “semiconductive layer” means a layer whose electrical conductivity may be strictly greater than 1×10⁻⁸ S/m (siemens per metre), preferably at least 1×10⁻³ S/m, and may preferably be less than 1×10³ S/m, measured at 25° C. in DC.

In the present invention, the term “semiconductive layer” means a layer whose volume resistivity (measured at 90° C.) is less than or equal to 1000 [Q*m].

The semiconductive layer of the invention may comprise at least one homophasic propylene polymer, at least one homophasic copolymer of a C₃-C₆ olefin and ethylene, optionally one or more additives, and optionally at least one conductive filler, the abovementioned ingredients being as defined in the invention.

The proportions of the various ingredients in the semiconductive layer may be identical to those as described in the invention for these same ingredients in the polymer composition.

The Cable

The elongated electrically conductive element may be a single-body conductor, for instance a metal wire, or a multi-body conductor such as a plurality of twisted or untwisted metal wires.

The elongated electrically conductive element may be made of aluminium, aluminium alloy, copper or copper alloy, and preferably copper or copper alloy.

In a preferred embodiment of the invention, the semiconductive layer is in direct physical contact with the elongated electrically conductive element. The semiconductive layer may then be an inner semiconductive layer.

In the present invention, the term “in direct physical contact” means that no layer of any kind is interposed between said elongated electrically conductive element and the semiconductive layer. In other words, the cable does not comprise any intermediate layer(s), notably layer(s) comprising at least one polymer, positioned between said elongated electrically conductive element and the semiconductive layer.

The cable may also comprise an electrically insulating layer.

According to the present invention, the term “electrically insulating layer” means a layer having an electrical conductivity which may be not more than about 1×10⁻⁸ S/m (siemens per metre), preferably not more than 1×10⁻⁹ S/m, and particularly preferably not more than 1×10⁻¹° S/m (siemens per metre), measured at 25° C. in DC.

More particularly, the electrically insulating layer has a lower electrical conductivity than that of the semiconductive layer. More particularly, the electrical conductivity of the semiconductive layer may be at least 10 times greater than the electrical conductivity of the electrically insulating layer, preferably at least 100 times greater than the electrical conductivity of the electrically insulating layer, and particularly preferably at least 1000 times greater than the electrical conductivity of the electrically insulating layer.

The electrically insulating layer of the invention preferably surrounds the elongated electrically conductive element.

The electrically insulating layer may surround the semiconductive layer. The semiconductive layer may then be an inner semiconductive layer.

The semiconductive layer may surround the electrically insulating layer. The semiconductive layer may then be an outer semiconductive layer.

The semiconductive layer of the cable of the invention is preferably an inner semiconductive layer. Specifically, in high voltage AC cable applications, it is particularly advantageous that at least the inner semiconductive layer between the elongated electrically conductive element and the electrically insulating layer has a smooth surface state since the gradient of the AC electric field in the cable under operating or test conditions is higher in this area.

The electrically insulating layer is preferably made of a thermoplastic polymer material, and particularly preferably obtained from a polymer composition comprising at least one polypropylene-based thermoplastic polymer material, notably comprising at least one homophasic propylene homo- or copolymer and/or at least one heterophasic propylene homo- or copolymer, and optionally at least one ethylene polymer.

According to a preferred embodiment of the invention, the electric cable comprises a plurality of semiconductive layers surrounding the elongated electrically conductive element, at least one of the semiconductive layers being as defined in the invention (or being obtained from a polymer composition as defined in the invention).

According to a particularly preferred embodiment of the invention, the cable comprises:
at least one elongated electrically conductive element, notably positioned at the centre of the cable,
a first semiconductive layer surrounding the elongated electrically conductive element,
an electrically insulating layer surrounding the first semiconductive layer, and
a second semiconductive layer surrounding the electrically insulating layer,

at least one of the semiconductive layers, preferably the first semiconductive layer, and particularly preferably both semiconductive layers, being as defined in the invention (or being obtained from a polymer composition as defined in the invention).

In a particular embodiment, the first semiconductive layer, the electrically insulating layer and the second semiconductive layer constitute a three-layer insulation. In other words, the electrically insulating layer is in direct physical contact with the first semiconductive layer, and the second semiconductive layer is in direct physical contact with the electrically insulating layer.

The cable may also comprise an outer protective sheath surrounding the second semiconductive layer, and may be in direct physical contact therewith.

The outer protective sheath may be an electrically insulating sheath.

The electric cable may also comprise an electrical shield (e.g. metallic) surrounding the second semiconductive layer. In this case, the outer protective sheath surrounds said electrical shield and the electrical shield is between the outer protective sheath and the second semiconductive layer.

This metallic shield may be a “wire shield” composed of a set of copper or aluminium conductors arranged around and along the second semiconductive layer, a “ribbon” shield composed of one or more conductive copper or aluminium metal ribbons which may be laid in a helix around the second semiconductive layer, or a conductive aluminium metal ribbon laid longitudinally around the second semiconductive layer and rendered leaktight by means of adhesive in the overlapping areas of parts of said ribbon, or a “leaktight” shield of the metal tube type, possibly composed of lead or lead alloy and surrounding the second semiconductive layer. This last type of shield can notably act as a barrier to moisture, which has a tendency to penetrate the electric cable in the radial direction.

The metal shield of the electric cable of the invention may comprise a “wire shield” and a “leaktight shield” or a “wire shield” and a “ribbon shield”.

All the types of metal shield may act as earthing for the electric cable and may thus transport fault currents, for example in the case of short-circuiting in the network concerned.

Other layers, such as layers which swell in the presence of moisture, may be added between the second semiconductive layer and the metal shield, these layers providing the longitudinal leaktightness to water of the electric cable.

The cable of the invention relates more particularly to the field of electric cables operating in direct current (DC) or alternating current (AC).

Process for Manufacturing the Cable

The electric cable according to the first subject of the invention may be obtained according to a process comprising at least one step 1) of extruding the polymer composition as defined in the first subject of the invention around an elongated electrically conductive element, to obtain a(n) (extruded) semiconductive layer surrounding said elongated electrically conductive element.

Step 1) may be performed via techniques that are well known to those skilled in the art, for example using an extruder.

During step 1), the composition leaving the extruder is said to be “non-crosslinked”, the processing temperature and time in the extruder being accordingly optimized.

At the extruder outlet, an extruded layer is thus obtained around said electrically conductive element, which may or may not be in direct physical contact with said elongated electrically conductive element.

The process preferably does not comprise a step of crosslinking the layer obtained in step 1).

The electrically insulating layer and/or the semiconductive layer(s) of the electric cable of the invention may be obtained by successive extrusion or by coextrusion.

Prior to the extrusion of each of these layers around at least one elongated electrically conductive element, all of the constituents required for the formation of each of these layers may be measured out and mixed in a continuous mixer such as a Buss co-kneader, a twin-screw extruder or another type of mixer suitable for polymer mixtures, notably mixtures containing fillers. The mixture may then be extruded in the form of rods, and then cooled and dried to be formed into granules, or else the mixture may be formed directly into granules, via techniques that are well known to those skilled in the art. These granules may then be introduced into a single-screw extruder so as to extrude and to deposit the composition around the elongated electrically conductive element to form the layer in question.

The various compositions may be extruded one after the other to successively surround the elongated electrically conductive element, and thus to form the various layers of the electric cable of the invention.

Alternatively, they may be extruded concomitantly by coextrusion using a single extruder head, coextrusion being a process that is well known to those skilled in the art.

Whether it is in the step of forming the granules or in the step of extrusion on the cable, the operating conditions are well known to those skilled in the art. In particular, the temperature in the mixing or extrusion device may be higher than the melting point of the predominant polymer or of the polymer having the highest melting point, among the polymers used in the composition to be implemented.

### BRIEF DESCRIPTION OF THE DRAWINGS

The attached drawings illustrate the invention:

FIG. 1 schematically represents a structure, in cross section, of a cable in accordance with the invention according to a first embodiment.

Other characteristics and advantages of the present invention will emerge in the light of the examples that follow with reference to the annotated figures, said examples and figures being given for illustrative purposes and not being in any way limiting.

FIG. 1 is a schematic view of an electric cable according to a preferred embodiment in accordance with the invention.

For the sake of clarity, only the elements that are essential for the understanding of the invention have been represented schematically, and are not to scale.

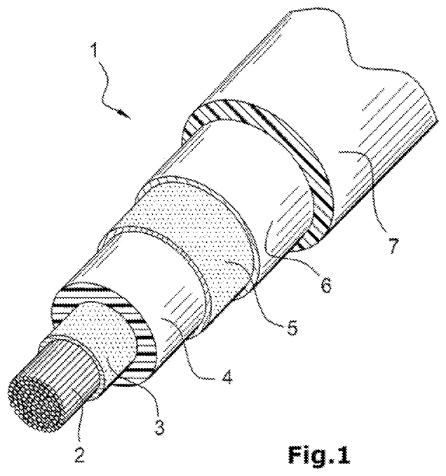

The medium-voltage or high-voltage electric cable 1 in accordance with the first subject of the invention, illustrated in FIG. 1, comprises a central elongated electrically conductive element 2, notably made of copper or aluminium. The electric cable 1 also comprises several layers arranged successively and coaxially around this central elongated electrically conductive element 2, namely: a first semiconductive layer 3, referred to as the “inner semiconductive layer”, an electrically insulating layer 4, a second semiconductive layer 5, referred to as the “outer semiconductive layer”, an earthing and/or protective metal shield 6, and an outer protective sheath 7.

The electrically insulating layer 4 is a thermoplastic (i.e. non-crosslinked) extruded layer.

The semiconductive layer 3 is a thermoplastic (i.e., non-crosslinked) extruded layer obtained from the polymer composition as defined in the invention.

The semiconductive layer 5 is a thermoplastic (i.e. non-crosslinked) extruded layer.

The presence of the metal shield 6 and of the outer protective sheath 7 is preferential, but not essential, this cable structure being, per se, well known to those skilled in the art.

### EXAMPLE

Polymer Compositions

Table 1 below shows a polymer composition in which the amounts of the compounds are expressed as weight percentages relative to the total weight of the polymer composition.

Composition I1 is a polymer composition in accordance with the invention.

TABLE 1

| Polymer composition | I1 |
|---|---|
| Homophasic propylene polymer | 36.00 |
| Homophasic copolymer of a C₃-C₆ | 32.00 |
| olefin and ethylene | |
| Conductive filler | 30.00 |
| Antioxidant | 1.50 |
| Metal deactivator | 0.50 |

The origin of the constituents collated in table 1 is as follows:
Homophase propylene polymer is a random copolymer of propylene and ethylene, sold by the company Borealis under the reference Bormed® RB 845 MO;
Homophasic copolymer of a C₃-C₆ olefin and ethylene is a copolymer of propylene and ethylene, sold by the company Dow under the reference Versify 2300;
Conductive filler is a furnace black, sold by the company Cabot, under the reference Vulcan XC-500;
Antioxidant is an antioxidant sold under the reference Irganox B225;
Metal deactivator is a metal deactivator sold under the reference Irganox MD1024; and
Dielectric fluid is sold by the company Nynas under the reference Nyflex 210B.

Preparation of a Strip Obtained from Polymer Composition I1

A strip 0.3 mm thick was extruded on a single-screw extruder equipped with a flat die to enable a surface state test to be performed. The extrusion temperatures are chosen according to the implementation properties of the polymer matrix and so as to obtain an extruded strip showing practically no deformation coming from the polymer matrix itself (e.g. non-molten matter, gels, particles coming from undesired crosslinking, or particles coming from degradation of one of the polymers of the polymer matrix). In addition, special care is taken to avoid deformations caused by the release of volatile substances that may be contained in the polymer composition. This thus makes it possible to measure protuberances or deformations mainly related to the process of dispersion and distribution of the conductive filler in the polymer matrix.

Characterization of the Surface State of the Strips

The test was performed as follows: the extruded strip obtained above is maintained under a constant mechanical tension by a system of rollers at a regulated speed and placed in motion by a winder. The strip thus advances into a measuring zone of an optical detection system consisting of a light source on one side of the measuring zone and a camera on the other side of the measuring zone.

The orientation of the detection system with respect to the moving strip surface is tangential. The in-line camera coupled to a computer simultaneously records images of the extruded strip surface and performs image analysis. The result is a detailed description of the number of defects present on the surface of the strip, classified by size and shape. The measurement is done by reflection. The results obtained are presented in Table 2 below and indicate the number of defects or protuberances per m².

Results

The results of the abovementioned surface state test, and of other mechanical and electrical tests, are collated in Table 2 below.

The tensile strength and elongation at break tests are performed according to the standard NF EN 60811-1-1, using a device sold under the reference 3345 by the company Instron. The tensile strength and the elongation at break are measured by means of a tensile test on an H2 dumbbell specimen, in particular at a tensile speed of 25 mm/min; in the initial state, or after thermal ageing in air, for example in an oven. The thermal ageing conditions chosen are as follows: duration of about 240 hours (10 days), and isothermal and constant temperature of about 135° C.

TABLE 2

| Characteristics | I1 |
|---|---|
| Number of protuberances per m² | 6 |
| Tensile strength [MPa] | 25.5 |
| Elongation at break [%] | 712 |
| Tensile strength [MPa] after 240 hours at | 25.8 |
| 135° C. in the oven in air | |
| Elongation at break [%] after 240 hours at | 605 |
| 135° C. in the oven in air | |
| Volume resistivity [Ohm · m] at 25° C. | 6.1 × 10⁻² |
| Volume resistivity [Ohm · m] at 100° C. | 2.6 × 10⁻¹ |

These results as a whole show that the semiconductive layer of the invention has a good surface state, notably a smooth appearance and a very low number of protuberances, while at the same time ensuring good mechanical and electrical properties.

1. An electric cable comprising:
at least one elongated electrically conductive element, and
at least one semiconductive layer surrounding said elongated electrically conductive element,
wherein the semiconductive layer is obtained from a polymer composition comprising at least one homophasic propylene polymer, and at least one homophasic copolymer of a C₃-C₆ olefin and ethylene.

2. The electric according to claim 1, wherein the polymer composition comprises at least 6% by weight of conductive filler, relative to the total weight of the polymer composition.

3. The electric according to claim 1, wherein the homophasic propylene polymer is a copolymer of propylene and ethylene.

4. The electric according to any one of the preceding claim 1, wherein the polymer composition comprises at least 20% by weight of the homophasic propylene polymer, relative to the total weight of the polymer composition.

5. The electric according to claim 1, wherein the polymer composition comprises at most 80% by weight of the homophasic propylene polymer, relative to the total weight of the polymer composition.

6. The electric according to claim 1, wherein the homophasic copolymer of a C₃-C₆ olefin and ethylene is a homophasic copolymer of propylene and ethylene.

7. The electric according to claim 1, wherein the polymer composition comprises at least 10% by weight of the homophasic copolymer of a C₃-C₆ olefin and ethylene relative to the total weight of the polymer composition.

8. The electric according to claim 1, wherein the polymer composition comprises at most 50% by weight of the polymer of the homophasic copolymer of a C₃-C₆ olefin and ethylene, relative to the total weight of the polymer composition.

9. The electric according to claim 1, wherein the homophasic copolymer of a C₃-C₆ olefin and ethylene is obtained by a copolymerization process using a metallocene catalyst.

10. The electric according to claim 1, wherein the homophasic propylene polymer and the homophasic copolymer of a C₃-C₆ olefin and ethylene represent at least 50% by weight, relative to the total weight of polymers in the polymer composition.

11. The electric according to claim 1, wherein the ethylene of the homophasic copolymer of a C₃-C₆ olefin and ethylene represents at most 25 mol % relative to the total number of moles of homophasic copolymer of a C₃-C₆ olefin and ethylene.

12. The electric according to claim 1, wherein the polymer composition also comprises a dielectric fluid.

13. The electric according to claim 1, wherein the semiconductive layer is a non-crosslinked layer.

14. The electric according to claim 1, wherein said electric cable also comprises an electrically insulating layer surrounding the elongated electrically conductive element.

15. The electric according to claim 14, wherein the electrically insulating layer surrounds the semiconductive layer.
